(19) United States
(12) Patent Application Publication
(10) Pub. No.: US 2022/0180620 A1
(43) Pub. Date: Jun. 9, 2022

(54) METHOD AND SYSTEM FOR IDENTIFYING OBJECTS FROM LABELED IMAGES OF SAID OBJECTS

(71) Applicants: SISPIA, VINCENNES (FR); THALES, COURBEVOIE (FR)

(72) Inventors: Stefan BERECHET, VINCENNES (FR); Ion BERECHET, VINCENNES (FR); Gérard BERGINC, ELANCOURT (FR)

(21) Appl. No.: 17/598,177

(22) PCT Filed: Mar. 16, 2020
(86) PCT No.: PCT/EP2020/057107

§ 371 Date: Sep. 24, 2021

(30) Foreign Application Priority Data
Mar. 28, 2019 (FR) 1903232

(51) Int. Cl. G06V 10/46; G06V 10/778; G06N 20/20

(52) U.S. Cl. CPC G06V 10/46; G06N 20/20; G06V 10/7788

(57) ABSTRACT

The system for identifying objects from images includes a module for aggregating and pooling images, the module receiving as input first, second and third pluralities of images labeled respectively by an expert in the field, through machine learning and through deep machine learning, and delivering as output a plurality of pooled labeled adjustment images having the best accuracy; and a module for aggregating and pooling invariants receiving as input the first, second and third pluralities of invariants labeled respectively by the expert in the field, through machine learning and through deep machine learning, and delivering as output a plurality of pooled labeled adjustment invariants having the best accuracy. In response to a new plurality of images of the object to be identified, the first, second and third identification modules are designed to use as input, separately and sequentially for the respective identification thereof, the plurality of pooled labeled adjustment images and/or the plurality of pooled labeled adjustment invariants originating from the aggregation and pooling modules.

The field of the invention is that of the identification of objects from labeled (tagged) images of said objects.

It is applicable in many sectors, which may range from facial and voice recognition, self-driving cars, civil and military robotics to the recognition of medical images, as well as the detection of defects in industry such as in the wood industry, for example.

In the example of the wood industry, what is understood by “labeled image” of a wood defect is an image in which a defect is linked to a known defect belonging to the group formed, for example, by crack, termite hole, or impact hole.

At least three different approaches are known for classifying, recognizing or identifying defects from labeled images of these defects.

First, there is the “expert in the field” approach, based on the experience and know-how of an expert on the object to be identified, for example an expert in the wood industry. The expert in the field then processes a large quantity of images of wooden beams as input and assigns a “label” corresponding to the presence or absence of a known defect as output. Such an approach is, for example, described in document U.S. Pat. No. 9,135,747B.

Second, there is the approach known in the field of artificial intelligence called “machine learning”, which works via automatic learning from a database of labeled invariants (attributes or characteristics). An algorithm is trained with a large amount of input data resulting in the creation of a model that allows an output to be delivered. The model is here a representation of the question posed and how to answer it.

Third, there is the approach known in the field of artificial intelligence called “deep learning”, which works by matching the images containing the object and the associated labels. Such an approach is, for example, described for facial recognition in US2015/0125049 from Facebook.

The first approach, by an expert in the field, is limited by expertise and human ability to classify complex objects. Generally, the success rate of the expert in the field is between 85% and 90% (success rate=number of successful identifications/number of identifications performed*100).

The second, machine learning, approach requires a representative, but not necessarily factorial, database of labeled invariants in order to be able to recognize or identify a given object. The success rate of this approach rarely or only slightly exceeds that of an expert in the field.

The third, deep learning, approach requires large labeled 2D/3D databases, obtained in a factorial manner. It succeeds in identifying a given object with a success rate or accuracy higher than 95%, hence the interest of this approach.

In practice, the concept of success rate is also referred to as the accuracy or confidence associated with the responses of the object identification models.

Hereinafter, the concept of accuracy is retained and it is specifically associated with the responses of each approach.

The drawback of the prior art lies in the fact that each approach is used individually or possibly in cascade, one after the other, without allowing interaction between the approaches. This leads to very long application times, discrepancies in the updating of the databases, or even in the extracted knowledge, and limitation in identification confidence.

In addition, as the automatic implementation of artificial intelligence techniques (machine learning, deep learning) in applications involving the detection, classification, recognition and identification of objects increases, the activity of an expert in the field decreases to the implicit detriment of their experience. In the short or medium term, this leads to the know-how of an expert in the field becoming impoverished while artificial knowledge becomes increasingly rich and broad.

The aim of the invention is to overcome the drawbacks of the identification approaches of the prior art.

It aims to make the three approaches work simultaneously and sequentially via parallel processes with pooled and continuous enrichment of the labeled databases required for the automatic learning of models.

It relates to a system for identifying an object from images of said object to be identified, comprising:
a module for extracting invariants of the object from images of said object;
a first identification module for identifying said object suitable for receiving as input the images of the object to be identified and the invariants originating from the invariant extraction module, and able to deliver as output a first plurality of images of said object labeled by an expert in the field, and a first plurality of invariants labeled by said expert in the field; said first identification module having a first identification accuracy corresponding to that of the expert in the field;
a second identification module suitable for receiving as input the images of the object to be identified and the invariants labeled by an expert in the field and able to deliver as output a second plurality of images of said object which are labeled through machine learning and a second plurality of invariants labeled through machine learning, said second identification module having a second accuracy corresponding to that of the machine learning; and
a third identification module suitable for receiving as input the images of the object to be identified and able to deliver as output a third plurality of images labeled through deep machine learning and a third plurality of invariants labeled through machine learning, said third identification module having a third accuracy corresponding to that of the deep machine learning.

According to a general definition of the invention, the system further comprises:
an aggregation and pooling module for aggregating and pooling labeled images receiving as input the first, second, and third pluralities of images labeled respectively by the expert in the field, through machine learning and through deep machine learning and delivering as output a plurality of pooled labeled adjustment images having the best accuracy; and
an aggregation and pooling module for aggregating and pooling labeled invariants receiving as input the first, second, and third pluralities of invariants labeled respectively by the expert in the field, through machine learning and through deep machine learning and delivering as output a plurality of pooled labeled adjustment invariants having the best accuracy; and
in response to a new plurality of images of the object to be identified, the first, second and third identification modules using as input, for the respective identification thereof, the plurality of pooled labeled adjustment images and/or the plurality of pooled labeled adjustment invariants originating from the aggregation and pooling modules.

By virtue of the invention, the identification system benefits not only from the result as output by the identification module exhibiting the best accuracy in the learning phase for the identification of a chosen object but also from reusing (pooling) the best identification result as input for the test (interrogation) phase in subsequent identifications of objects to be processed.

This results in identification leading to better results.

Thus, the identification system in accordance with the invention makes it possible to overcome the drawbacks of each individual approach, to decrease discrepancies in the updating of the databases, or in the extracted knowledge, and increases the accuracies of each respective approach by virtue of the pooling of the databases (2D/3D images, 2D/3D invariants coupled with the best accuracy) enriched with the best answer.

Surprisingly, it is by pooling the databases resulting from the identification modules via expert in the field, machine learning and deep learning in parallel and synergistically rather than in a silo manner as in the prior art and by choosing the best accuracy that an efficient identification system may be obtained, moreover without resulting in substantial additional processing time.

In practice, a pooled database of labeled images is sequentially and continuously enriched with the results of the image aggregation and pooling module.

Likewise, a pooled database of labeled invariants is sequentially and continuously enriched with the results of the invariant aggregation and pooling module.

According to one embodiment, the best pooled accuracy is equal to the maximum between the accuracy of the expert in the field, the accuracy of the machine learning and the accuracy of the deep learning.

According to another embodiment, the pooled adjustment label is equal to the expert in the field label if the expert in the field accuracy is higher than the machine learning accuracy and the deep learning accuracy, the pooled label of the object is equal to the machine learning label if the machine learning accuracy is higher than the deep learning accuracy and the expert in the field accuracy, the pooled label is equal to the deep learning label if the deep learning accuracy is higher than the expert in the field accuracy and the machine learning accuracy.

According to yet another embodiment, the labeled adjustment images are obtained by consolidating the images of the object with the pooled label of the object.

According to yet another embodiment, the pooled labeled adjustment invariants are obtained by consolidating the aggregated invariants with the pooled label of the object, the aggregated invariants are obtained by aggregating the expert in the field labeled invariants, the machine learning labeled invariants and deep learning labeled invariants.

Another subject of the present invention is a method for identifying an object from labeled images of said object implemented by said identification system in accordance with the invention.

The present invention also relates to a computer program that is downloadable from a communication network and/or recorded on a medium that is readable by computer and/or executable by a processor, which computer program comprises instructions for executing the method in accordance with the invention when said program is executed on a computer.

Other features and advantages of the invention will become apparent from reading the following detailed description, which is given by way of non-limiting example and with reference to the appended drawings, in which:

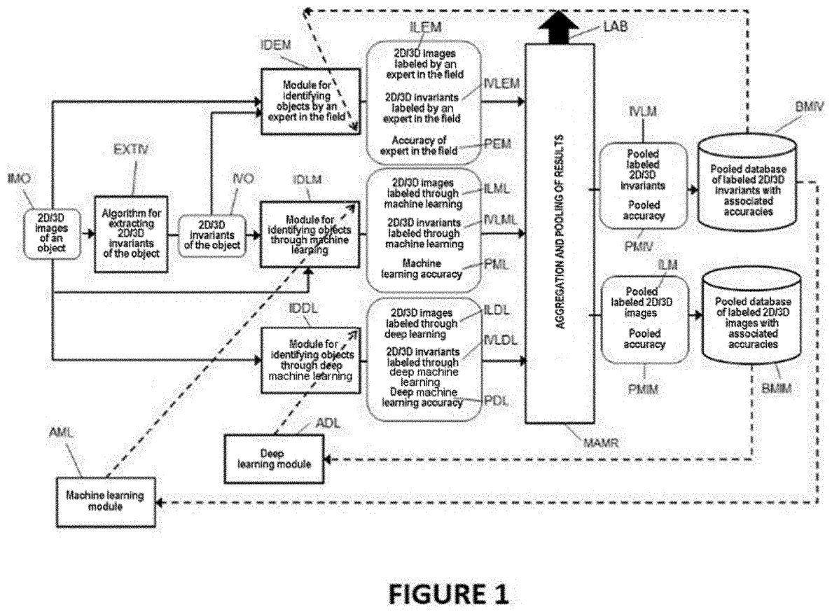

FIG. 1 schematically shows the aggregation and pooling of the results of three approaches: expert in the field, machine learning and deep learning,

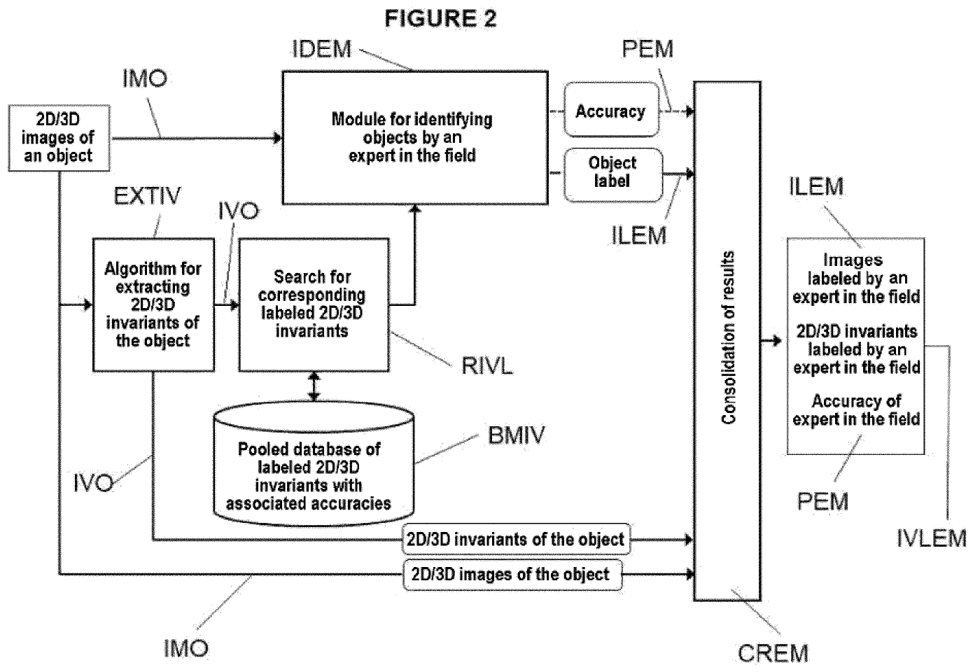

FIG. 2 schematically shows the process for identifying objects by the expert in the field calling on the pooled database of labeled 2D/3D invariants,

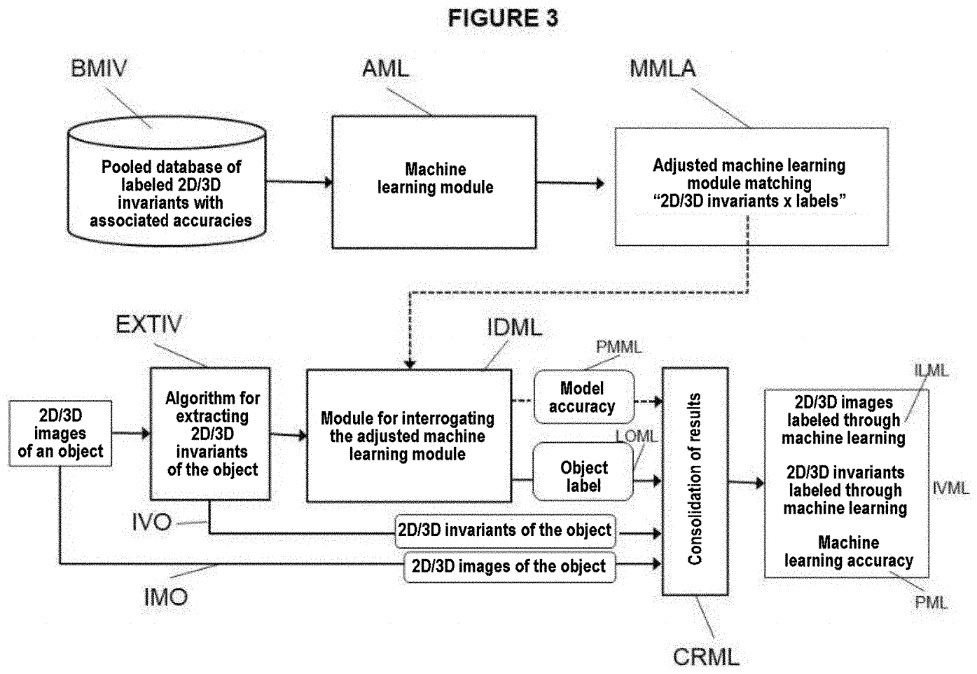

FIG. 3 schematically shows the complete process for learning and identifying objects through machine learning using the pooled database of labeled 2D/3D invariants,

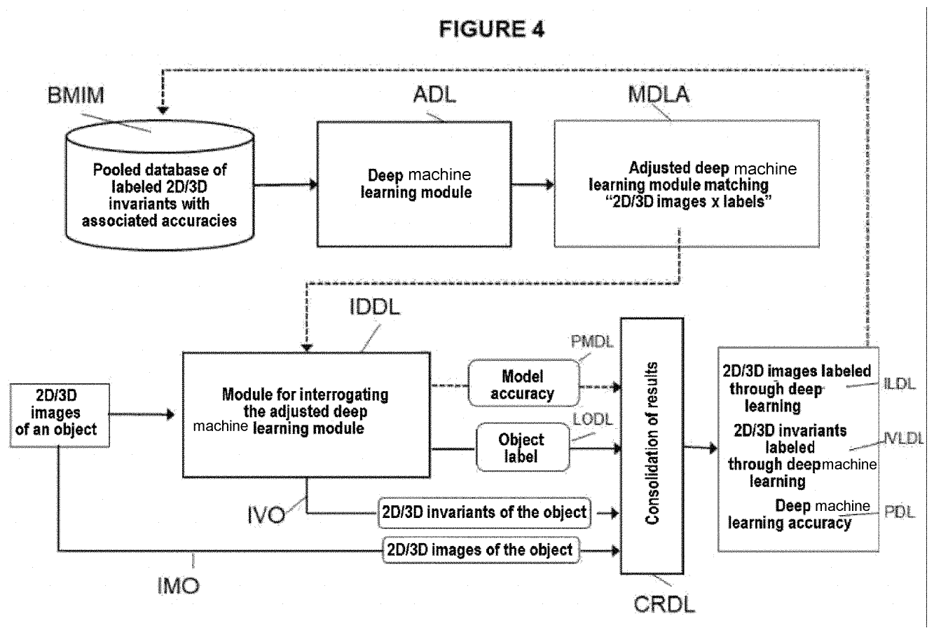

FIG. 4 schematically shows the complete process for learning and identifying objects through deep learning using the pooled database of labeled 2D/3D images,

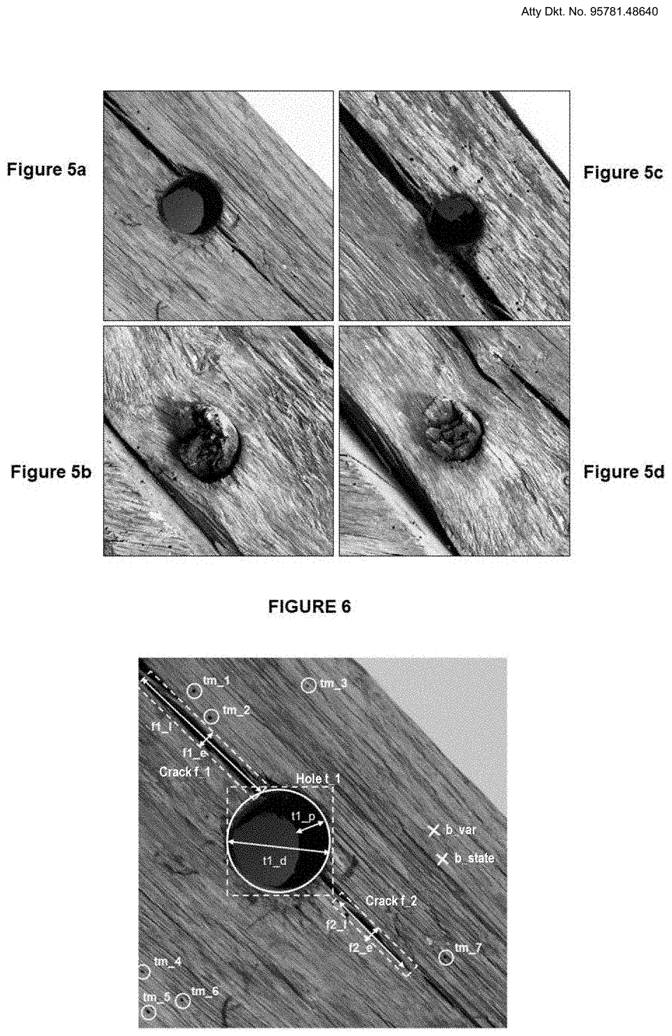

FIG. 5a, b, c, d are illustrations of 2D images of defects to be identified and associated labels,

FIG. 6 is a label obtained via the expert in the field approach, and

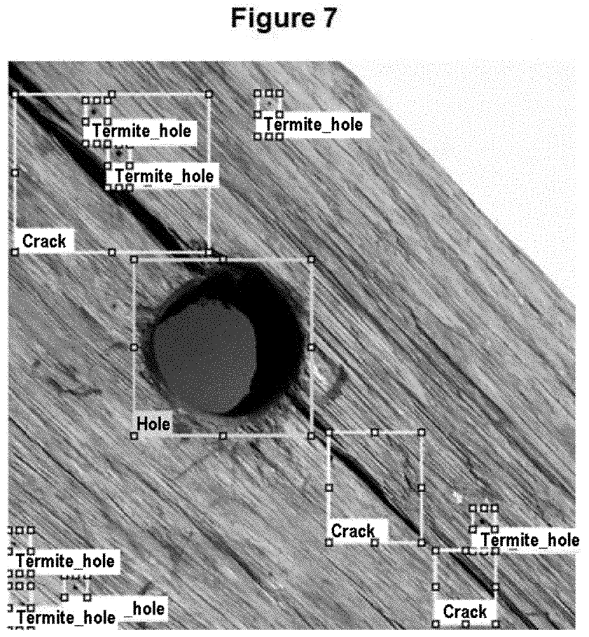

FIG. 7 is a label obtained via the deep learning approach.

In all of the figures, elements that are the same have been designated with the same references.

FIG. 1, shows a system for identifying objects that uses the three identification approaches, expert in the field, machine learning and deep learning, in parallel.

First, the system comprises a first identification module IDEM trained by an expert in the field EM receiving as input images IMO of an object to be identified (2D and/or 3D images), invariants IVO extracted by an extraction algorithm EXTIV.

For example, in the wood industry, the invariants thus extracted belong to the group formed by the texture, the area, the filled area and the empty area, the equivalent diameter, the length of the major axis, the length of the minor axis, the perimeter, etc.

As output, the first identification module IDEM delivers images of the object labeled ILEM by the expert in the field (human) according to predefined rules related to the object to be identified and to the expert's field, invariants labeled by the expert in the field IVLEM, and an accuracy PEM of the expert in the field EM.

For example, in identifying defects in a wooden beam, the hole belongs to the list of specific labels in the wood industry. Here the hole (FIG. 6) in the beam has been identified by the expert in the field with the label “Hole t_1”.

Second, the identification system comprises a second identification module IDLM trained through machine learning which receives as input images IMO of an object to be identified (2D and/or 3D images), invariants (geometric or other invariants) and invariants IVO extracted by the extraction algorithm EXTIV.

As output, the second identification module IDDL delivers images of the object labeled ILML through machine learning, labeled invariants IVLML, and an accuracy of the machine learning PML.

Third and finally, the identification system also further comprises a third identification module IDDL trained through deep machine learning or “deep learning” which receives as input images IMO of an object to be identified (2D and/or 3D images).

As output, the third identification module IDDL delivers images of the object ILDL labeled through deep learning, labeled invariants IVLDL, and an accuracy PDL of the deep learning.

The third identification module IDDL has an accuracy PDL corresponding to that of the deep machine learning.

As will be seen in more detail below, provision is made to use an algorithmic aggregation and pooling module MAMR which receives the results from three approaches, expert in the field EM, machine learning ML and deep learning DL in order to pool the results from the learning and retain only those that have the best accuracy in order to reuse them in the identification of new images of the object to be processed in the test phase.

In practice, the module MAMR has as inputs:
the 2D/3D images ILEM of the object labeled by the expert in the field, the 2D/3D invariants IVLEM of the object labeled by the expert in the field and the accuracy of the expert in the field PEM,
the 2D/3D images of the object labeled through machine learning ILML, the 2D/3D invariants of the object labeled through machine learning IVLML and the accuracy of the machine learning PML,
the 2D/3D images of the object labeled through deep learning ILDL, the 2D/3D invariants IVLDL of the object labeled through deep learning and the accuracy of the deep learning PDL.

As output, the module MAMR generates:
pooled and labeled 2D/3D images of the object ILM,
pooled and labeled 2D/3D invariants of the object IVLM,
a pooled image accuracy PMIM and a pooled invariant accuracy PMIV.

Advantageously, the pooled accuracies PMIM and PMIV are chosen so as to be equal to the maximum between the accuracy of the expert in the field PEM, the accuracy of the machine learning PML and the accuracy of the deep learning PDL.

The aggregation and pooling module delivers as output a result which corresponds to the pooled, retained label, also called “Label LAB” for the object.

The pooled, retained label LAB is equal to:
the label for the object given by the expert in the field EM if the accuracy of the expert in the field PEM is higher than the accuracy of the machine learning PML and the accuracy of the deep learning PDL,
the label for the object given by machine learning if the accuracy of the machine learning PML is higher than the accuracy of the deep learning PDL and the accuracy of the expert in the field PEM,
the label for the object given by deep learning if the accuracy of the deep learning PDL is higher than the accuracy of the expert in the field PEM and the accuracy of the machine learning PML.

The pooled labeled 2D/3D images are obtained by consolidating the 2D/3D images of the object with the pooled label LAB for the object.

The pooled labeled 2D/3D invariants are obtained by consolidating the aggregated invariants with the pooled label LAB for the object.

The aggregated 2D/3D invariants are obtained by aggregating the invariants labeled by the expert in the field, the invariants labeled by machine learning and the invariants labeled by deep learning.

Very advantageously, the pooled labeled 2D/3D images and the associated pooled accuracies will enrich a pooled database of labeled 2D/3D images BMIM with associated accuracies PMIM. Likewise, the pooled labeled 2D/3D invariants and the pooled accuracies will enrich a pooled database of labeled 2D/3D invariants BMIV with associated accuracies PMIV.

The pooled database of labeled 2D/3D images BMIM with associated accuracies PMIM will be used to adjust the identification modules IDLM and IDDL (shown in dashed line in FIG. 1). The pooled database of labeled 2D/3D invariants BMIV with associated accuracies PMIV will be used by the module IDEM (shown in dashed line in FIG. 1).

The complete process of enriching and using the pooled databases of labeled data BMIM (images) and BMIV (invariants) comprises many steps of data acquisition and processing.

The 2D/3D images IMO of an object to be identified are sent:
to approach 1 of identifying objects IDEM by the expert in the field (FIG. 2),
to an algorithmic module for extracting 2D/3D invariants EXTIV of the object (FIG. 2),
to approach 3 IDDL of identifying objects through deep learning (FIG. 4),

The algorithmic module for extracting 2D/3D invariants EXTIV generates the 2D/3D invariants IVO of the object from the 2D/3D images IMO of the object.

The 2D/3D invariants IVO of the object are sent:
to approach 1 of identifying objects IDEM by the expert in the field (FIG. 2),
to approach 2 IDLM of identifying objects through machine learning (FIG. 3),

With reference to the FIG. 2, approach 1 of identifying objects IDEM by the expert in the field generates as output:
the 2D/3D images of the object labeled by the expert in the field ILEM,
the 2D/3D invariants of the object labeled by the expert in the field IVLEM,
the accuracy of the expert in the field PEM,

from its inputs:
the 2D/3D images of the object to be identified,
the 2D/3D invariants of the object.

With reference to the FIG. 3, approach 2 of identifying objects through machine learning generates as output:
the 2D/3D images of the object labeled through machine learning ILML,
the 2D/3D invariants of the object labeled through Machine Learning IVML,
the accuracy of the machine learning PML,

from its inputs:
the 2D/3D images of the object to be identified,
the 2D/3D invariants of the object.

With reference to the FIG. 4, approach 3 of identifying objects through deep learning generates as output:
the 2D/3D images of the object labeled ILDL through deep learning,
the 2D/3D Invariants of the object labeled through deep learning IVLDL,
the accuracy of the deep learning PDL,

from its inputs, the 2D/3D images of the object to be identified.

With reference to the FIG. 2, in response to new images IMO of the object to be identified (test phase), the complete process for identifying objects by the expert in the field will call on the pooled database of labeled 2D/3D invariants BMIV to adjust its human identification if the invariants stored in the database exhibit better accuracy than those from the extraction module EXTIV.

First, the new 2D/3D images IMO of an object to be identified are sent:
to the expert in the field to identify the object,
to an algorithmic module for extracting 2D/3D invariants EXTIV of the object,
to an algorithmic module for consolidating the results CREM.

Conventionally, the algorithmic module for extracting 2D/3D invariants EXTIV generates the 2D/3D invariants of the object from the 2D/3D images of the object.

The 2D/3D invariants IVO of the object are sent: to a module for searching for the labeled 2D/3D invariants RIVL corresponding to the pooled database of labeled 2D/3D invariants with associated accuracies BMIV, to an algorithmic module for consolidating results CREM.

When the search is positive, i.e. when the labeled 2D/3D invariants from the pooled database of 2D/3D invariants BMIV are better than those from the extraction module, then the labeled invariants with associated accuracies from the database BMIV are sent in turn to the expert in the field as an aid for human identification of the object. Otherwise, in the event of a negative search, the expert uses the invariants resulting from the extraction module EXTIV.

The expert in the field generates the label for the object ILEM and the associated accuracy PEM on the basis of the invariants thus updated and optimized by virtue of the database of labeled and pooled invariants.

The algorithmic module for consolidating the results CREM generates the 2D/3D images of the object labeled by the expert in the field, the 2D/3D invariants of the object labeled by the expert in the field and the accuracy of the expert in the field by consolidating (associating) the label for the object with the 2D/3D images of the object, with the 2D/3D invariants of the object and with the associated accuracy.

Similarly, in the phase of testing on new images to be processed, the complete process of identifying objects through machine learning will call on the pooled database of labeled 2D/3D invariants (FIG. 3). The process comprises two interacting phases.

First, the process comprises a machine learning phase in order to adjust (optimize, update) the machine learning model on the matching of 2D/3D invariants and labels on the basis of the invariants from the pooled database of labeled 2D/3D invariants with associated accuracies.

Second (in the test phase), the process comprises a phase of interrogating the machine learning model IDML, adjusted during the learning phase, which comprises the following elements:
the 2D/3D images of an object to be identified are sent:
to an algorithmic module for extracting 2D/3D invariants of the object,
to an algorithmic module for consolidating the results,

the algorithmic module for extracting 2D/3D invariants generates the 2D/3D invariants of the object from the 2D/3D images of the object,

the 2D/3D invariants of the object are sent:
to a module for interrogating the adjusted machine learning model,
to the algorithmic module for consolidating the results,

the module for interrogating the adjusted machine learning model generates the label for the object and the associated accuracy,

The algorithmic module for consolidating the results generates the 2D/3D images of the object labeled through machine learning, the 2D/3D invariants of the object labeled through machine learning and the accuracy of the machine learning by consolidating (associating) the label for the object with the 2D/3D images of the object, with the 2D/3D invariants of the object and with the associated accuracy.

Similarly, the complete process for identifying objects through deep learning will call on the pooled database of labeled 2D/3D images (FIG. 4). This process also comprises two interacting phases.

First, a deep learning learning phase makes it possible to adjust the deep learning model on the matching of 2D/3D images x labels from the pooled database of labeled 2D/3D images with associated accuracies.

Second (in the test phase), the process comprises a phase of interrogating the deep learning model IDDL, adjusted during the learning phase.

In practice, the 2D/3D images of an object to be identified are sent: to a module for interrogating the adjusted deep learning model IDDL, to an algorithmic module for consolidating the results CRDL.

The module for interrogating the adjusted deep learning model IDDL simultaneously generates the label for the object, the associated accuracy and the 2D/3D invariants of the object,

The algorithmic module for consolidating the results CRDL generates the 2D/3D images of the object labeled through deep learning, the 2D/3D invariants of the object labeled through deep learning and the accuracy of the deep learning by consolidating (associating) the label for the object with the 2D/3D images of the object, with the 2D/3D invariants of the object and with the associated accuracy.

With reference to FIGS. 5a to 5d, an example of four images of a wooden beam comprising anomalies or defects to be identified is illustrated.

In FIGS. 5a to 5d, a plurality of possible defects on a beam are shown: crack, termite hole, impact hole, etc.

The problem here is to identify what is an unacceptable defect in the wood industry over a large quantity of wooden beams to be processed.

For example, in identifying defects in a wooden beam, the hole belongs to the list of specific labels in the wood industry. Here the hole (FIG. 6) in the beam has been identified by the expert in the field and machine learning and labeled with the label “Hole t_1”.

In FIG. 7, this same hole has been identified and labeled by deep learning with the label “Hole”. Each identification module (EM, ML, DL) has the same label but with a different accuracy.

With reference to the FIG. 6 labels obtained by the expert in the field approach for anomalies or defects on one of the images of the wooden beam are shown:

### Hole t_1:

t1_loc: location of Hole_1 [x1,y1,x2,y2]
t1_d: diameter of Hole_1 in mm
t1_p: depth of Hole_1 in mm

### Crack f_1:

f1_loc: location of Crack_1 [x1,y1,x2,y2]
f1_l: length of Crack_1 in mm
f1_e: thickness of Crack_1 in mm

### Crack f_2:

f2_loc: location of Crack_2 [x1,y1,x2,y2]
f2_l: length of Crack_2 in mm
f2_e: thickness of Crack_2 in mm
   Termite holes tm_(n):
tm1_loc: location holes_termites_1 [x1,y1]
tm2_loc: location holes_termites_2 [x1,y1]
tm3_loc: location holes_termites_3 [x1,y1]
tm4_loc: location holes_termites_4 [x1,y1]
tm5_loc: location holes_termites_5 [x1,y1]
tm6_loc: location holes_termites_6 [x1,y1]
tm7_loc: location holes_termites_7 [x1,y1]

### Wood:

b_var: variety of wood
b_state: condition of the wood (good, medium, bad).

With reference to FIG. 7, labels obtained via the deep learning approach and the regions of interest associated with the anomalies or defects are shown in the same image of the wooden beam. These labels are of the type: hole, crack and termite hole.

By way of non-limiting example, the structure for the machine learning approach used for the classification of defects (supervised learning) is of support-vector machine (SVM) type.

By way of non-limiting example, the structure for the deep learning approach used for the detection and classification of defects is of “Faster R-CNN (regions with convolutional neural network features) object classification” type.

By way of non-limiting example, the aggregation of invariants uses adaptive Boolean operators: AND, OR and XOR. Other methods are applicable: Bayesian probabilistic methods, Dempster-Shafer method based on belief theory, Borda Count ranking methods, ordered weighted averaging operator (OWA), aggregator weight-functional operator (AWFO), hidden Markov chains (CMC), inference rule-based fuzzy logic and artificial neural networks.

Thus, the invention makes it possible to overcome the drawbacks of each individual approach, to decrease discrepancies in the updating of the databases, or in the extracted knowledge, and increases the accuracies of each respective approach by virtue of the pooling of the databases (2D/3D images, 2D/3D invariants coupled with the best accuracy) enriched with the best answer.

By virtue of the invention:
the deep learning approach uses the labels acquired in learning through the expert in the field approach and the labels from the machine learning approach,
the machine learning approach uses the invariants acquired in learning through the expert in the field approach and the invariants from the deep learning approach,
the expert in the field approach uses the invariants from the deep learning approach and the invariants from the machine learning approach, for better identification accuracy.

In addition, the identification system benefits not only from the result as output by the identification module exhibiting the best accuracy in the learning phase for the identification of a chosen object but also from reusing (pooling) the best identification result as input for the test phase in subsequent identifications of objects to be processed.

The fields of application of the invention are broad, covering the detection, classification, recognition and identification of objects of interest.

1. A system for identifying an object from images of said object to be identified, comprising:
a module for extracting invariants (EXTIV) of the object from images of said object;
a first identification module (IDEM) for identifying said object suitable for receiving as input the images of the object to be identified and the invariants originating from the invariant extraction module, and able to deliver as output a first plurality of images of said object labeled by an expert in the field (EM), and a first plurality of invariants labeled by said expert in the field (EM); said first identification module (IDEM) having a first identification accuracy (PEM) corresponding to that of the expert in the field (EM);
a second identification module (IDML) suitable for receiving as input the images of the object to be identified and the invariants originating from the invariant extraction module and able to deliver as output a second plurality of invariants labeled through machine learning and a second plurality of images of said object labeled through matching with the labeled invariants, said second identification module (IDML) having a second accuracy (PML) corresponding to that of the machine learning; and
a third identification module (IDDL) suitable for receiving as input the images of the object to be identified and able to deliver as output a third plurality of images labeled through deep machine learning and a third plurality of invariants labeled through deep machine learning, said third identification module (IDDL) having a third accuracy (PDL) corresponding to that of the deep machine learning;
further comprising:
an aggregation and pooling module (MAMR) receiving as input the first, second, and third pluralities of images labeled respectively by the expert in the field, through machine learning and through deep machine learning and delivering as output a plurality of pooled labeled adjustment images having the best accuracy; and
the aggregation and pooling module (MAMR) also receiving as input the first, second, and third pluralities of invariants labeled respectively by the expert in the field, through machine learning and through deep machine learning and also delivering as output a plurality of pooled labeled adjustment invariants having the best accuracy; and
in that in response to receiving a new plurality of images of the object to be identified, the first, second and third identification modules are designed to use as input, separately and sequentially for the respective identification thereof, the plurality of pooled labeled adjustment images and/or the plurality of pooled labeled adjustment invariants originating from the aggregation and pooling module (MAMR).

2. The system as claimed in claim 1, further comprising a pooled database of labeled images sequentially and continuously enriched with the results from the aggregation and pooling module.

3. The system as claimed in claim 1, further comprising a pooled database of labeled invariants sequentially and continuously enriched with the results from the aggregation and pooling module.

4. The system as claimed in claim 1, wherein the best accuracy (PMIM) is equal to the maximum between the accuracy of the first module (PEM), the accuracy of the second module (PML) and the accuracy of the third module (PDL).

5. The system as claimed in claim 1, wherein the pooled adjustment label (LAB) is equal to the label from the first module (ILEM) if the accuracy of the first module (PEM) is higher than the accuracy of the second (PML) and of the third module (PDL); in that the object adjustment label (LAB) is equal to the label from the second module (ILML) if the accuracy of the second module is higher than that of the third (PDL) and the first module (PEM), and that the adjustment label (LAB) is equal to that of the third module if the accuracy of the third module is higher than that of the first (PEM) and than that of the second module (PML).

6. The system as claimed in claim 1, wherein the labeled adjustment images are obtained by consolidating the images of the object with the adjustment label of the object.

7. The system as claimed in claim 1, wherein the pooled labeled adjustment invariants are obtained by consolidating the aggregated invariants with the adjustment label of the object.

8. The system as claimed in claim 1, wherein the aggregated invariants are obtained by aggregating the labeled invariants from the first, second and third identification modules.

9. A method for identifying an object from labeled images of said object implemented by a system as claimed in claim 1.

10. A computer program that is downloadable from a communication network and/or recorded on a medium that is readable by computer and/or executable by a processor, comprising instructions for executing the method as claimed in claim 9 when said program is executed on a computer.
